(19) United States
(12) Patent Application Publication
(10) Pub. No.: US 2011/0072063 A1
(43) Pub. Date: Mar. 24, 2011

(54) Abstraction Apparatus for Processing Data

(75) Inventors: Yoon-Soo Kim, Suwon-si (KR); Hee-Kuk Lee, Suwon-si (KR)

(73) Assignee: Samsung Electronics Co., Ltd., Suwon-si (KR)

(21) Appl. No.: 12/880,260

(22) Filed: Sep. 13, 2010

(30) Foreign Application Priority Data
Sep. 22, 2009 (KR) 10-2009-0089783

(51) Int. Cl. G06F 7/00

(52) U.S. Cl. 708/205; 708/204

(57) ABSTRACT

An abstraction apparatus for processing data is provided. The abstraction apparatus implements an abstraction layer that supports a variety of physical objects (hardware). The abstraction apparatus only manages information related to data denormalization and/or denormalization separately without embedding the information in the logical objects (software), thereby reducing overhead due to the normalization and/or denormalization.

### CROSS-REFERENCE TO RELATED APPLICATION(S)

This application claims the benefit under 35 U.S.C. §119(a) of Korean Patent Application No. 10-2009-0089783, filed on Sep. 22, 2009, the entire disclosure of which is incorporated herein by reference for all purposes.

### BACKGROUND

1. Field

The following description relates to data processing, and more particularly, to an abstraction apparatus for processing large amounts of data between a physical object and a logical object.

2. Description of the Related Art

Generally, a software system that supports a variety of hardware includes a hardware abstraction layer to ensure that a higher-level software module is independent from the hardware. If a higher-level software module uses only an application program interface (API) provided by the hardware abstraction layer, the higher-level software module is not affected by changes in hardware which only influence the hardware abstraction layer.

However, the use of an abstraction layer generally increases the amount of overhead because functions cannot directly accesses hardware. As a result, the use of an abstraction layer leads to performance degradation in comparison to when hardware is directly accessed.

For example, an abstraction layer that manages a large amount of data may cause more significant performance degradation because conversion overhead is further incurred. The conversion overhead may be due to data normalization or denormalization in addition to the overhead caused by overlapping function calls.

In object-oriented programming, conversion overhead caused by data normalization or denormalization may be increasingly generated. Although only a few attributes of an object are required for data normalization or denormalization in object-oriented programming, generally the object itself performs a variety of processes and has a significant memory capacity.

### SUMMARY

In one general aspect, there is provided an abstraction apparatus for processing data between one or more physical objects at a hardware level and one or more logical objects at a software level, the apparatus comprising a normalization information storing unit configured to store normalized data and normalization components according to indices of the individual logical objects, and a normalization processing unit configured to convert data input from the one or more physical objects into normalized data to be used by the one or more logical object by updating the input data according to the stored normalization components, and configured to store the converted normalized data in the normalization information storing unit according to the indices of the logical objects.

The normalization processing unit may perform an arithmetic operation using the stored normalization component and the data input from the one or more physical objects to create the normalized data.

The normalization component may be a normalization constant and an arithmetic operation may be performed on the normalization constant and the input data to convert the input data into the normalized data.

The normalization component comprises a normalization function which includes the input data as a function argument.

The normalization information storing unit may store the normalization components and the normalized data in contiguous memory areas according to the indices of the individual logical objects.

In another aspect, there is provided an abstraction apparatus for processing data between one or more physical objects at a hardware level and one or more logical objects at a software level, the apparatus comprising a denormalization information storing unit configured to store denormalized data and denormalization components according to indices of the individual physical objects, and a denormalization processing unit configured to convert data from the one or more logical objects into denormalized data to be used by the one or more physical objects by updating the output data according to the stored denormalization components, and configured to store the denormalized data in the denormalization information unit according to the indices of the respective physical objects.

The denormalization processing unit may perform an arithmetic operation using the stored denormalization component and the data output from the one or more logical objects to create the denormalized data.

The denormalization component may be a denormalization constant and an arithmetic operation may be performed on the denormalization constant and the output data to convert the output data into the normalized data.

The denormalization component comprises a denormalization function which includes the output data as a function argument.

The denormalization processing unit may store the denormalization components and the denormalized data in contiguous memory areas according to the indices of the respective physical objects.

In another aspect, there is provided an abstraction apparatus for processing data between one or more physical objects at a hardware level and one or more logical objects at a software level, the abstraction apparatus comprising a normalization information storing unit configured to store normalized data and normalization components according to indices of the individual logical objects, a normalization processing unit configured to convert data input from the one or more physical objects into normalized data to be used by the one or more logical objects by updating the input data according to the stored normalization components, and configured to store the converted normalized data in the normalization information storing unit according to the indices of the logical objects, a denormalization information storing unit configured to store denormalized data and denormalization components according to indices of the individual physical objects, and a denormalization processing unit configured to convert data output from the one or more logical objects into denormalized data to be used by the one or more physical objects by updating the output data according to the stored denormalization components, and configured to store the denormalized data in the denormalization information unit according to the indices of the respective physical objects.

The normalization processing unit may perform an arithmetic operation on the stored normalization component and the input data from the one or more physical objects to create the normalized data.

The normalization component may be a normalization constant.

The normalization component comprises a normalization function which includes the input data as a function argument.

The normalization information storing unit may store the normalization components and the normalized data in contiguous memory areas according to the indices of the individual logical objects.

The denormalization processing unit may perform an arithmetic operation on the stored denormalization component and the output data from the one or more logical objects to create the denormalized data.

The denormalization component may be a denormalization constant.

The denormalization component comprises a denormalization function which includes the output data as a function argument.

The denormalization processing unit may store the denormalization components and the denormalized data in contiguous memory areas according to the indices of the respective physical objects.

The abstraction apparatus may further comprise a delay unit configured to create a time delay between normalization by the normalization processing unit and denormalization by the denormalization processing unit.

Other features and aspects may be apparent from the following description, the drawings, and the claims.

### BRIEF DESCRIPTION OF THE DRAWINGS

FIG. 1 is a diagram illustrating an example of an abstraction apparatus for processing data.

FIG. 2 is a diagram illustrating an example of normalized data and normalization components which are stored according to indices of individual logical objects.

FIG. 3 is a diagram illustrating an example of storing normalized data and normalization components in contiguous memory areas.

FIG. 4 is a diagram illustrating another example of an abstraction apparatus for processing data.

FIG. 5 is a diagram illustrating an example of denormalized data and denormalization components which are stored according to indices of physical objects.

FIG. 6 is a diagram illustrating an example of storing of denormalized data and denormalization components in contiguous memory areas.

FIG. 7 is a diagram illustrating another example of an abstraction apparatus for processing data.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

As described herein, normalization refers to a process that converts input data received from a physical object (hardware) into a form capable of being used by a logical object (software). Denormalization refers to a process that converts output data from a logical object into denormalized data that is capable of being used by a physical object.

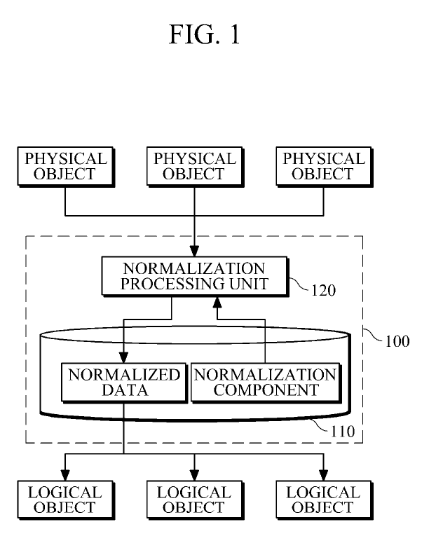

FIG. 1 illustrates an example of an abstraction apparatus for processing data. Referring to FIG. 1, abstraction apparatus 100 includes a normalization information storing unit 110 and a normalization processing unit 120. The abstraction apparatus 100 may be included in a terminal, such as a computer, a mobile terminal, and desktop computer, and the like.

The normalization information storing unit 110 stores normalized data and normalization components according to indices of individual logical objects. The normalized data may be obtained by converting input data from one or more physical objects into a form capable of being used by one or more logical objects (software).

For example, the normalization component may be a normalization constant or a normalization function. The normalized data may be generated by performing various arithmetic operations on the normalization constant and data that is input from various physical objects (hardware). The normalized data may be generated by performing arithmetic operations on the normalization function which includes the input data from the physical object(hardware) as a function argument.

The normalized data may be data related to the motion control of a robot, for example, the location, the speed, the torque, and the like, of the robot. In addition, the normalized data may be data in various forms and may be acquired by various physical objects (hardware). The normalized data may be used to control the environmental conditions such as temperature, humidity, and the like. The indices of the individual logical objects indicate a storage location of the normalized data and the normalization component. For example, the indices of the individual logical objects may be memory addresses or table indices.

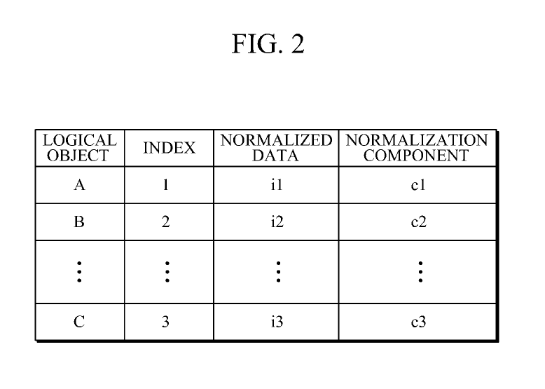

FIG. 2 illustrates an example of normalized data and normalization components. In this example, the normalized data and the normalization components are stored according to indices of individual logical objects. Referring to FIG. 2, logical objects A, B, and C are allocated with indices “1,” “2,” and “3,” respectively. In addition, normalized data i1, i2, and i3 and normalization components c1, c2, and c3 are stored in the logical objects A, B, and C, respectively.

In this example, the normalized data storing unit 110 (see FIG. 1) stores the normalized data and the normalization components separately in different memory areas. The normalized data and the normalization components may be stored according to the indices of the logical objects. Alternatively, the normalized data storing unit 110 may store both the normalized data and the normalization components simultaneously in contiguous memory areas, according to the indices of the logical objects.

When the normalized data and the normalization components are stored in contiguous memory areas, both the normalized data and the normalization component may be simultaneously loaded into a cache memory. Thus, integrated processing may be achieved.

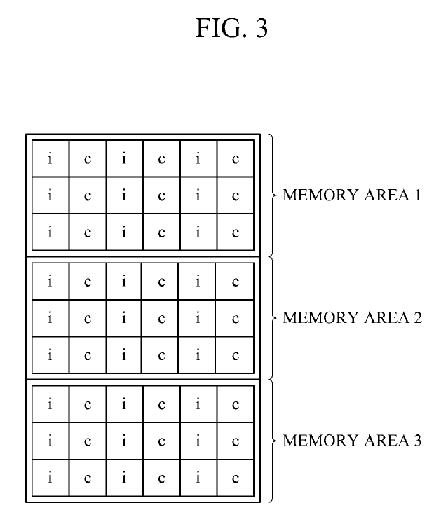

FIG. 3 illustrates an example of storing normalized data and normalization components in contiguous memory areas. Referring to FIG. 3, data pairs, each consisting of normalized data and a normalization component, are stored sequentially in memory. In FIG. 3, the normalized data is denoted by “i,” and the normalization component is denoted by “c.”

By storing the normalized data and the normalization components in contiguous memory areas, the normalized data and the normalization components may be simultaneously loaded into a cache memory. Accordingly, the memory transmission bandwidth that is wasted in the cache memory when a cache miss occurs during data normalization may be reduced. As a result, the normalization may be processed up to as fast as the maximum speed supported by a central processing unit (CPU).

Referring back to FIG. 1, the normalization processing unit 120 converts input data from the physical objects into normalized data that can be used by each logical object. The conversion of the input data may be performed by updating the input data according to the normalization components which are stored in the normalization information storing unit 110. The normalized data may be stored in the normalization information storing unit 110 according to the indices of the respective logical objects.

The normalization processing unit 120 may generate normalized data by performing arithmetic operations on data input from one or more physical objects and the normalization component. For example, the normalization processing unit 120 may perform an arithmetic operation on a normalization constant and the input data from the physical object (hardware), or on a normalization function which includes the input data from the physical object(hardware) as a function argument. The normalization constant and the normalization function may vary.

Accordingly, the abstraction apparatus may process large amounts of data and may implement an abstraction layer that supports various physical objects (hardware). The abstraction apparatus may manage information related to data normalization separately without embedding the information in the logical objects (software). In addition, the abstraction apparatus may define storage locations of the information in the individual logical objects. As a result, overhead due to the normalization may be reduced, and the overall system performance may be improved.

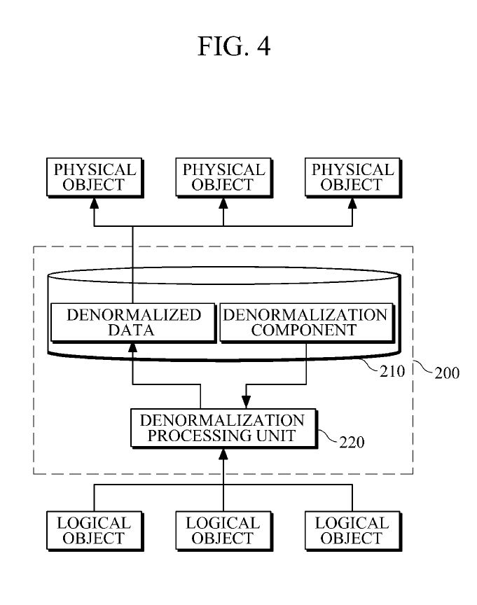

FIG. 4 illustrates another example of an abstraction apparatus for processing data. Referring to FIG. 4, abstraction apparatus 200 includes a denormalization information storing unit 210 and a denormalization processing unit 220.

The denormalization information storing unit 210 stores denormalized data and denormalization components according to indices of individual physical objects. The denormalized data may be generated by converting data that is output from a logical object (software) into a form that may be used by one or more physical objects (hardware).

For example, the denormalization component may be a denormalization constant or a denormalization function. The denormalized data may be generated by performing an arithmetic operation on data output from the logical object (software) and the normalization constant, or on a denormalization function which includes the output data from the logical object(software) as a function argument.

The denormalized data may include information related to motion control of a robot, such as a location, a speed, a torque, and the like. In addition, the denormalized data may be data in various formats which are instructed by the logical object for the purpose of controlling environmental conditions such as temperature, humidity, and the like. The index of each physical object may include information indicating a storage location of a denormalization component, for example, a memory address or a table index.

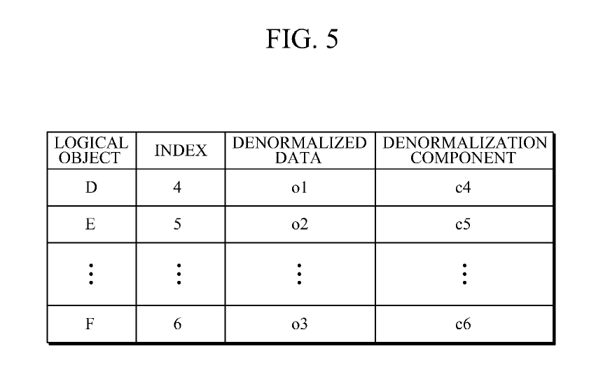

FIG. 5 illustrates an example of denormalized data and denormalization components which are stored according to indices of physical objects. Referring to FIG. 5, indices “4,” “5,” and “6” are allocated to physical objects D, E, and F, respectively. Additionally, the physical objects D, E, and F store denormalized data o1, o2, and o3 and denormalization components c4, c5, and c6, respectively.

The denormalization information storing unit 210 (see FIG. 4) may store the denormalized data and the denormalized components separately. For example, the denormalized data and the denormalized components may be stored in distributed memory areas according to the indices of the respective physical objects. In some embodiments, the denormalization storing unit 210 may store the denormalized data and the denormalized components simultaneously in contiguous memory areas according to the indices of the respective physical objects.

If the denormalized data and the denormalization components are stored simultaneously in contiguous memory areas, both the denormalized data and the denormalization component may be loaded unit by unit into a cache memory, and integrated processing may be performed.

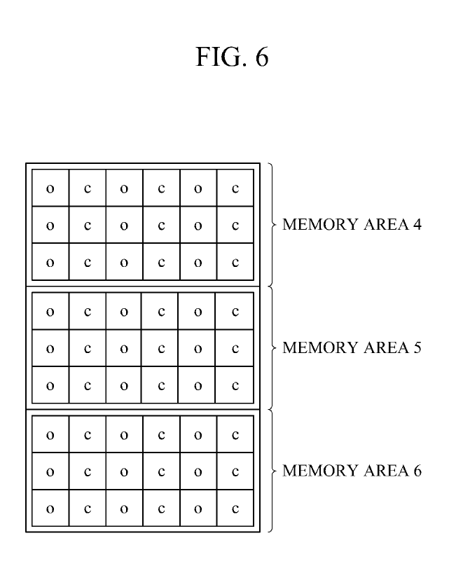

FIG. 6 illustrates an example of storing of denormalized data and denormalization components in contiguous memory areas. Referring to FIG. 6, data pairs corresponding to physical objects, each consisting of normalized data and a denormalization component, are stored sequentially in contiguous memory areas. In FIG. 6, the denormalized data is represented by “o,” and the denormalization component is represented by “c.”

The storing of the denormalized data and the denormalization components in contiguous memory areas allows simultaneous loading of the denormalized data and the denormalization components to a cache memory. Accordingly, it is possible to reduce the amount of memory transmission bandwidth wasted in the cache memory when a cache miss occurs during data denormalization. As a result, the denormalization may be processed up to the maximum speed supported by a CPU.

Referring back to FIG. 4, the denormalization processing unit 220 converts the data output from each logical object into denormalized data to be used by one or more physical objects. The denormalization processing unit 220 converts the data by updating the output data according to the denormalization component corresponding to the index of each physical object that is stored in the denormalization information storing unit 210. The denormalization processing unit stores the denormalized data in the denormalization information storing unit 210 according to the index of the corresponding physical object.

In some embodiments, the denormalization processing unit 220 may generate the denormalized data by performing an arithmetic operation using the stored denormalization component and the data output from one or more logical objects. For example, the denormalization processing unit 220 may perform an arithmetic operation on a denormalization constant and the data output from the logical object (software), or on a denormalization function which includes the output data from the logical object(software) as a function argument. In some embodiments, the denormalization constant and the denormalization function may be varied.

Accordingly, the example abstraction apparatus may process a large amount of data by implementing an abstraction layer that supports various physical objects (hardware) while managing information related to data denormalization separately without embedding the information in the logical objects (software). In addition, the abstraction apparatus may define storage locations of the information in the individual physical objects. As a result, overhead due to the denormalization may be reduced and overall system performance may be improved.

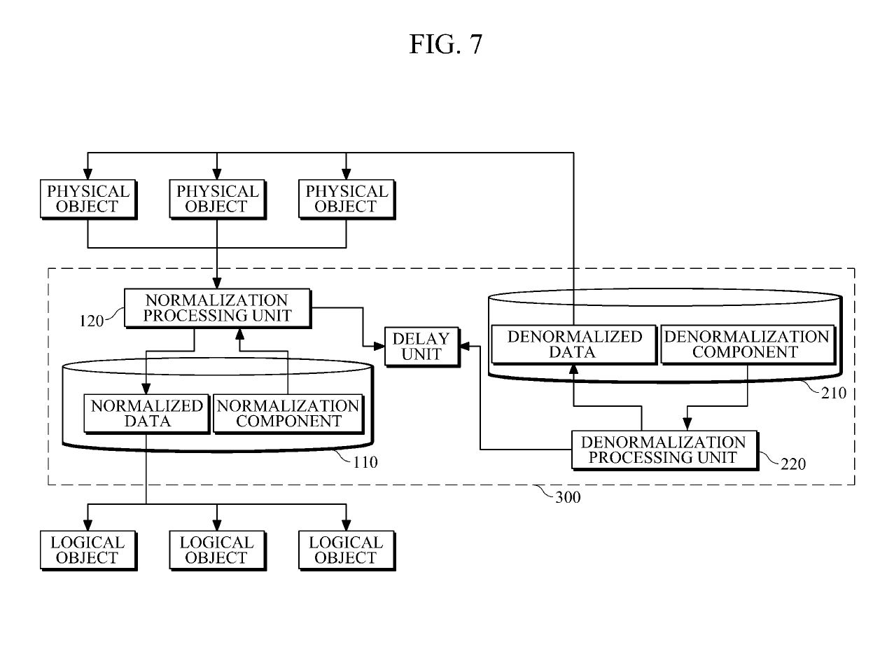

FIG. 7 illustrates another example of an abstraction apparatus for processing data. Referring to FIG. 7, abstraction apparatus 300 includes a normalization information storing unit 110, a normalization processing unit 120, a denormalization information storing unit 210, and a denormalization processing unit 220.

In this example, the abstraction apparatus 300 is implemented as an integrated apparatus by combining the normalization information storing unit 110 and the normalization processing unit 120 shown in the example illustrated in FIG. 1, and combining the denormalization information storing unit 210 and the denormalization processing unit 220 shown in the example illustrated in FIG. 4. Accordingly, the abstraction apparatus 300 shown in the example illustrated in FIG. 7 can perform both normalization and denormalization.

The abstraction apparatus 300 may be implemented to perform the normalization and the denormalization simultaneously or in any order. In the example illustrated in FIG. 7, the same reference numerals as in the examples illustrated in FIGS. 1 and 4 refer to the same elements, and thus their operations are omitted for conciseness.

The abstraction apparatus may process a large amount of data and may implement an abstraction layer to support various physical objects (hardware) while managing information related to data denormalization and/or denormalization separately without embedding the information in the logical objects (software). Also, the abstraction apparatus may define storage locations of the information related to the normalization in the individual logical objects only and storage locations of the information related to the denormalization in the individual physical objects only. As a result, overhead due to the normalization and denormalization is reduced, and overall system performance is improved.

In some embodiments, as shown in FIG. 7, the abstraction apparatus 300 may further include a delay unit 310. The delay unit 310 may create a time delay between the normalization performed by the normalization processing unit 120 and the denormalization performed by the denormalization processing unit 220.

By implementing a time delay, the abstraction apparatus 300 may perform the normalization and the denormalization in any order with a predetermined time delay.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An abstraction apparatus for processing data between one or more physical objects at a hardware level and one or more logical objects at a software level, the apparatus comprising:
a normalization information storing unit configured to store normalized data and normalization components according to indices of the individual logical objects; and
a normalization processing unit configured to:
convert data input from the one or more physical objects into normalized data to be used by the one or more logical object by updating the input data according to the stored normalization components; and
store the converted normalized data in the normalization information storing unit according to the indices of the logical objects.

2. The abstraction apparatus of claim 1, wherein the normalization processing unit is further configured to perform an arithmetic operation using the stored normalization component and the data input from the one or more physical objects to create the normalized data.

3. The abstraction apparatus of claim 2, wherein:
the normalization component comprises a normalization constant; and
an arithmetic operation is performed on the normalization constant and the input data to convert the input data into the normalized data.

4. The abstraction apparatus of claim 2, wherein the normalization component comprises a normalization function which includes the input data as a function argument.

5. The abstraction apparatus of claim 1, wherein the normalization information storing unit is further configured to store the normalization components and the normalized data in contiguous memory areas according to the indices of the individual logical objects.

6. An abstraction apparatus for processing data between one or more physical objects at a hardware level and one or more logical objects at a software level, the apparatus comprising:
a denormalization information storing unit configured to store denormalized data and denormalization components according to indices of the individual physical objects; and
a denormalization processing unit configured to:
to convert data from the one or more logical objects into denormalized data to be used by the one or more physical objects by updating the output data according to the stored denormalization components; and
store the denormalized data in the denormalization information unit according to the indices of the respective physical objects.

7. The abstraction apparatus of claim 6, wherein the denormalization processing unit is further configured to perform an arithmetic operation using the stored denormalization component and the data output from the one or more logical objects to create the denormalized data.

8. The abstraction apparatus of claim 7, wherein:
the denormalization component comprises a denormalization constant; and
an arithmetic operation is performed on the denormalization constant and the output data to convert the output data into the normalized data.

9. The abstraction apparatus of claim 7, wherein the denormalization component comprises a denormalization function which includes the output data as a function argument.

10. The abstraction apparatus of claim 6, wherein the denormalization processing unit is further configured to store the denormalization components and the denormalized data in contiguous memory areas according to the indices of the respective physical objects.

11. An abstraction apparatus for processing data between one or more physical objects at a hardware level and one or more logical objects at a software level, the abstraction apparatus comprising:
a normalization information storing unit configured to store normalized data and normalization components according to indices of the individual logical objects;
a normalization processing unit configured to:
convert data input from the one or more physical objects into normalized data to is be used by the one or more logical objects by updating the input data according to the stored normalization components; and
store the converted normalized data in the normalization information storing unit according to the indices of the logical objects;
a denormalization information storing unit configured to store denormalized data and denormalization components according to indices of the individual physical objects; and
a denormalization processing unit configured to:
convert data output from the one or more logical objects into denormalized data to be used by the one or more physical objects by updating the output data according to the stored denormalization components; and
store the denormalized data in the denormalization information unit according to the indices of the respective physical objects.

12. The abstraction apparatus of claim 11, wherein the normalization processing unit is further configured to perform an arithmetic operation on the stored normalization component and the input data from the one or more physical objects to create the normalized data.

13. The abstraction apparatus of claim 12, wherein the normalization component comprises a normalization constant.

14. The abstraction apparatus of claim 12, wherein the normalization component comprises a normalization function which includes the input data as a function argument.

15. The abstraction apparatus of claim 11, wherein the normalization information storing unit is further configured to store the normalization components and the normalized data in contiguous memory areas according to the indices of the individual logical objects.

16. The abstraction apparatus of claim 11, wherein the denormalization processing unit is further configured to perform an arithmetic operation on the stored denormalization component and the output data from the one or more logical objects to create the denormalized data.

17. The abstraction apparatus of claim 16, wherein the denormalization component comprises a denormalization constant.

18. The abstraction apparatus of claim 16, wherein the denormalization component comprises a denormalization function which includes the output data as a function argument.

19. The abstraction apparatus of claim 11, wherein the denormalization processing unit is further configured to store the denormalization components and the denormalized data in contiguous memory areas according to the indices of the respective physical objects.

20. The abstraction apparatus of claim 11, further comprising a delay unit configured to create a time delay between normalization by the normalization processing unit and denormalization by the denormalization processing unit.
